(19) United States
(12) Patent Application Publication
(10) Pub. No.: US 2012/0023706 A1
(43) Pub. Date: Feb. 2, 2012

(54) Hinge stop

(76) Inventor: Timothy Fuller, Rolling Meadows, IL (US)

(21) Appl. No.: 12/804,787

(22) Filed: Jul. 29, 2010

(51) Int. Cl. E05D 11/06

(52) U.S. Cl. 16/374

(57) ABSTRACT

A hinge comprising a first plate having at least one first cylindrical member provided on an end thereof is set forth. A second plate having at least one second cylindrical member provided on an end thereof is provided. A pin is provided through the at least one first cylindrical member and the at least one second cylindrical member for rotatably connecting the first plate to the second plate. At least one stop is formed on the exterior of the at least one first cylindrical member for limiting rotation of the second plate with respect to the first plate.

### CROSS-REFERENCE TO RELATED APPLICATION

None.

### BACKGROUND

Early hinges were formulated to operably connect heavy, solid wood doors. The knobs and other hardware mounted to such doors could cause considerable damage to, for example, plaster walls if opened rapidly. As a result, a number of structures to impede either the door or the hinge have been developed through the years.

The following patents provide some examples of attempts to modify hinges to prevent damage to walls: U.S. Pat. Nos. 2,280,655, 3,602,942, 3,971,099, 4,738,002, 4,998,941, 5,727,289, and 5,881,431.

Often, the known implementations to reduce or slow the travel of a hinge are cumbersome and/or reduce the integrity of the hinge by the removal of structure from the rotating cylinder members.

### SUMMARY

A durable hinge with integrated stops includes stops formed on the exterior of the rotating cylinder members near top and bottom.

### BRIEF DESCRIPTION OF THE DRAWINGS

Embodiments of the invention are illustrated by way of example, and not by way of limitation, in the figures of the accompanying drawings and in which like reference numerals refer to similar elements and in which:

FIG. 1 illustrates a perspective view of an embodiment of a hinge with integrated stop assembly in accordance with the principles of the present invention.

FIG. 2 illustrates a top plan view of the FIG. 1 hinge with integrated stop assembly with the hinge plates in a closed position.

FIG. 3 illustrates a top plan view of the FIG. 1 hinge with integrated stop assembly with the hinge plates in an open position.

### DETAILED DESCRIPTION

In the following description, specific details are set forth in order to provide a thorough understanding of the invention. However, it will be apparent that the invention may be practiced without these specific details. Without departing from the generality of the invention disclosed herein and without limiting the scope of the invention, the discussion that follows, will refer to the invention as depicted in the drawings.

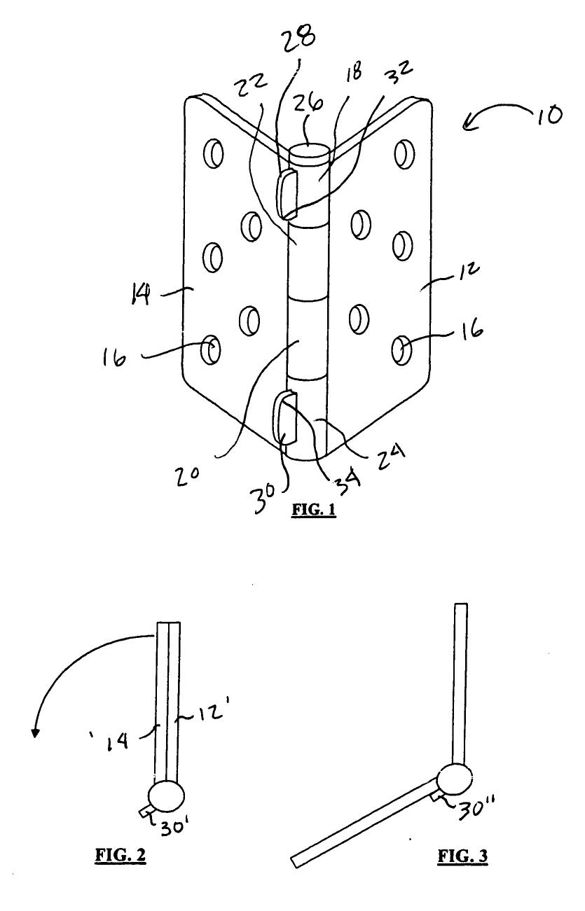

As shown in FIG. 1 a durable hinge 10 includes a first plate 12 and a second plate 14. The first and second plates 12, 14 can be secured to an operable opening structure, such a a door or a window via any suitable means, such as with screws (not shown) secured, for example, through apertures 16 in the first and second plates 12, 14. The plates 12, 14 can be formed of any suitable material, such as, for example, brass, steel, steel alloy, plated metal, or any other suitable material, and can include one or more cylindrical members, such as cylindrical members 18, 20, 22, and 24, respectively, for securing plate 12 to plate 14 via a generally cylindrical pin 26. Other hinge configurations having, for example, a single cylinder on one plate and a pair of cylinders on a second plate is contemplated herein. Cylindrical members 18, 20 can be fixedly attached to plate 14, while cylindrical members 22, 24 can be fixedly attached to plate 12. At least one hinge stop, such as hinge stops 28, 30 can be provided on at least one of the cylinders, such as, for example, on cylinder 18 of plate 14 and on cylinder 24 of plate 12. The at least one hinge stop is secured to or integrally formed with at least one of the cylindrical members 18, 20, 22, 24. For example, the cylinder and hinge stop can both be formed of the same material, such as a metal or combination of metals, and the hinge stop can be formed during the of the same stock as the cylinder. Alternatively, the cylinder and hinge stop can be formed of common or mixed materials, and the hinge stop can be suitable adhered to the cylinder, such as by welding, using a metal post, or any other suitable method.

The at least one hinge stop can be decorative or plain and formed in a suitable shape, such as a generally rectangular shape, and can be rounded at ends 32, 34, if desired. The structural consideration regarding the shape of the hinge stop is strength, as it is important that the stop does not break during operation of the hinge.

In operation, the plates 12′, 14′ of the hinge 10 can be separated by rotating at least one of the plates 12, 14. As illustrated in FIG. 2, for example, plate 14′ can be rotated counterclockwise in the direction of the arrow toward the stop 30′ until it comes into contact with the stop 30′. The stop 30″ prevents the swinging operation from proceeding further, as illustrated in FIG. 3.

While this invention has been described in connection with the best mode presently contemplated by the inventor for carrying out his invention, the preferred embodiments described and shown are for purposes of illustration only, and are not to be construed as constituting any limitations of the invention. Modifications will be obvious to those skilled in the art, and all modifications that do not depart from the spirit of the invention are intended to be included within the scope of the appended claims. Those skilled in the art will appreciate that the conception upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The invention resides not in any one of these features per se, but rather in the particular combinations of some or all of them herein disclosed and claimed and it is distinguished from the prior art in these particular combinations of some or all of its structures for the functions specified.

With respect to the above description then, it is to be realized that the optimum dimensional relationships for the parts of the invention, including variations in size, materials, shape, form, function and manner of operation, assembly and use, and all equivalent relationships to those illustrated in the drawings and described in the specification, that would be deemed readily apparent and obvious to one skilled in the art, are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim as my invention:

1. A hinge comprising:
a first plate having at least one first cylindrical member provided on an end thereof;
a second plate having at least one second cylindrical member provided on an end thereof;
a pin provided through the at least one first cylindrical member and the at least one second cylindrical member for rotatably connecting the first plate to the second plate; and
at least one stop formed on the exterior of the at least one first cylindrical member for limiting rotation of the second plate with respect to the first plate.
